(19) United States
(12) Patent Application Publication
(10) Pub. No.: US 2024/0396930 A1
(43) Pub. Date: Nov. 28, 2024

(54) SYSTEM AND METHOD FOR SCORING AND RANKING COMMON WEAKNESSES MAPPED TO VULNERABILITIES FOUND IN NETWORKED AND/OR DISTRIBUTED SYSTEMS

(71) Applicant: GEORGE MASON UNIVERSITY, Fairfax, VA (US)

(72) Inventors: Massimiliano Albanese, Potomac, MD (US); Ibifubara Iganibo, Seattle, WA (US)

(21) Appl. No.: 18/647,604

(22) Filed: Apr. 26, 2024

Related U.S. Application Data
(60) Provisional application No. 63/504,090, filed on May 24, 2023.

(51) Int. Cl. H04L 9/40

(52) U.S. Cl. CPC H04L 63/1441; H04L 63/1433

(57) ABSTRACT

A method of performing prioritized remediation for a distributed system includes: obtaining cyber security; outputting a standard security weakness ranking based on the cyber security data; determining that one or more vulnerabilities exist in one or more system components of the distributed system based on the standard security weakness ranking; customizing metrics for calculating an exploitation likelihood and an exposure factor associated with a vulnerability based on a user input including at least one variable influencing the likelihood or the exposure factor and capturing a specific applicative domain of each vulnerability, priorities of the system, types of potential attackers; calculating the customized metrics; outputting a customized ranking of the one or more vulnerabilities based on the calculation; and performing a prioritized remediation of a target vulnerability selected by the user based on the customized ranking and specific needs and resources of the system.

### CROSS REFERENCE TO RELATED APPLICATIONS

This application claims priority to U.S. Provisional Patent Application No. 63/504,090, filed May 24, 2023, entitled “Scoring and Ranking Common Weaknesses Mapped to Vulnerabilities Found in Networked/Distributed Systems,” the disclosure of which is herein incorporated by reference in its entirety.

### STATEMENT OF GOVERNMENT-FUNDED RESEARCH

This invention was made with government support under grant number 1822094 awarded by the National Science Foundation. The government has certain rights in the invention.

### FIELD OF THE INVENTION

The disclosed concept relates generally to a system and method for improving the security of a networked and/or distributed system, in particular a system and method for scoring and ranking common weaknesses mapped to vulnerabilities found in networked and/or distributed systems.

### BACKGROUND OF THE INVENTION

As the world becomes increasingly connected, organizations in all industrial, government, military, non-profit, educational, etc. entities face constant cyber-attacks by malicious actors. Despite the organizational efforts to guard against incoming attacks and protect sensitive data, the costs and resulting losses from successful attacks continue to rise. For example, it has been reported that the average cost of a data breach in 2021 was $4.24 million, which is a 10% rise from that in 2019. Indeed, as of 2021, cybercrimes (e.g., damage and destruction of data, stolen money, lost property, and intellectual property theft, etc.) have reportedly cost the world almost $600 billion each year, 0.8% of the global GDP. Such high financial losses due to lack of security as well as an increase in vulnerabilities across the globe, more stringent regulatory standards and data privacy compliance requirements, a surge in the adoption of Internet of Things (IoT) and cloud-based systems, and the integration of advanced technologies such as Artificial Intelligence (AI) and Machine Learning (ML) have led to an exponential growth in the security and vulnerability management market, reportedly valued at $6.61 billion in 2020 and expected to reach $11.72 billion by 2026.

However, given the significant number of interconnected components in the distributed systems or composed systems (e.g., the IoT system or a networked Industrial Control System (ICS)), providing the appropriate level of security for such networked systems may pose a challenge. For example, a first line of defense against cyber-attacks may be to evaluate the weaknesses and vulnerabilities of a system that may be exposed to malicious users. While the terms “weakness” and “vulnerability” are often used interchangeably, they in fact represent two distinct levels of abstraction. That is, a “vulnerability” is a flaw or defect, commonly found in software or hardware, which has the potential to be exploited by attackers for malicious purposes. A “weakness” is a condition in a software, firmware, hardware, or service component, that, under certain circumstances, could contribute to the introduction of vulnerabilities. The Common Vulnerabilities and Exposures (CVE) system was introduced to provide a unified method for publicly disclosing security vulnerabilities, and it is referenced as a standard in the cybersecurity world. The Common Weakness Enumeration (CWE) is a system that provides a structured list of software and hardware weakness types that serves as a foundational resource for identifying, mitigating, and preventing weaknesses. While the CWE serves as a comprehensive list of software vulnerabilities, with a focus on foundational errors, the CVE encompasses documented instances of vulnerabilities associated with specific systems or products. Each CVE can be mapped to one or more CWE entries and each CWE entry encompass numerous (sometimes hundreds) different vulnerabilities. The purpose of classifying CVEs into CWE is to provide an easy way to identify specific types of weaknesses and also understand the nature of vulnerabilities. The CWE facilitates the identification and recognition of specific types of vulnerabilities and enables deeper analysis of the root causes and common patterns associated with specific weaknesses. Thus, while the terms “weakness” and “vulnerability” are often used interchangeably, they in fact represent two distinct levels of abstraction. Several techniques and tools have been developed to work at either level of abstraction, but no approaches to bridging the gap between these two abstraction levels have been developed.

For example, MITRE and OWASP (Open Web Application Security Project) provide periodic rankings of software weaknesses and software vulnerability scoring systems. However, the rankings offer limited solutions because they abstract the details of individual vulnerabilities and reason for the vulnerabilities in terms of weaknesses, but provide only generic rankings that are not useful to understand the security posture of a specific system. For vulnerabilities, topological vulnerability analysis and numerous scoring and ranking systems have been developed, including multi-layer graph approaches to configuration analysis and optimization using vulnerability graphs and various scanning tools to identify the specific vulnerabilities that exist in each component of a distributed system. However, they do not aggregate the information at a higher level of abstraction, rendering it difficult for a security analyst to derive actionable intelligence from voluminous scanning reports. For example, the Common Vulnerability Scoring System (CVSS) often returns the same severity score and rank for a plurality of vulnerabilities, leaving the security personnel unable to differentiate severities between those vulnerabilities. Further, the rankings of common weaknesses are based on knowledge about all known vulnerabilities rather than the specific vulnerabilities that exist in the system being evaluated, resulting in overestimating or underestimating the true severity of the weaknesses. Furthermore, the scoring systems rely on predefined notions of risk and use fixed equations to compute numerical scores, and thus do not provide users with the flexibility to fine-tune such equations or consider new variables. For example, susceptibility of a vulnerability to becoming a target for exploitation by malicious users depends on a number of variables including features of the vulnerability itself and characteristics of potential attackers. Many of the existing approaches have focused on intrinsic features of vulnerabilities, but not extrinsic features such as the types, skills, and resources available to the potential attackers. As such, these approaches focus on scoring and comparing vulnerabilities for a fixed attack surface or model based on fixed equations and predefined security risks, thereby failing to provide a user the ability to modify or adjust the vulnerability assessment in accordance with the specific needs of the distributed system being protected.

Thus, current solutions lack a principled approach to quantifying various dimensions of problems in a manner in which the scoring and rankings of vulnerabilities can be adapted to various applicative domains and operating conditions of individual systems. Further, they neither account for the individual need of a specific system nor allow for prioritizing remediation of software security risks based on the needs and resources of the specific system. This results in a generalized security risk assessment ineffective or unfit for the individual system, leading to improper or inefficient security measurement adoptions and leaving the individual systems exposed to malicious attackers and potential business and financial losses.

There is room for improvement in cyber security solutions against constant and rapidly evolving cyber-attack landscape.

### SUMMARY OF THE INVENTION

These needs, and others, are met by a method of performing prioritized remediation of security weaknesses in a distributed system. The method includes: obtaining cyber security data including at least vulnerability data and intrusion detection system (IDS) rules; outputting a standard security weakness ranking based on the cyber security data; determining that one or more vulnerabilities exist in one or more system components of the distributed system based on the standard security weakness ranking; customizing metrics for calculating a likelihood of exploitation of each vulnerability and an exposure factor associated with exploitation of each vulnerability based on a user input including at least one variable for use in the calculation, the at least one variable influencing the likelihood of exploitation or the exposure factor and capturing specific applicative domain of each vulnerability, priorities of the distributed system and/or types of potential attackers; calculating the customized metrics; outputting a customized ranking of the one or more vulnerabilities based on the calculated customized metrics; and performing a prioritized remediation of a target vulnerability selected by the user from the one or more vulnerabilities based on the customized ranking and specific needs and resources of the distributed system.

In some example embodiments, the at least one variable belongs to a first set Xₗ^{↑} of variables that contribute to increasing the likelihood of exploitation as the value of the first set increases, a second set Xₗ^{↓} that contribute to decreasing the likelihood of exploitation as the value of the second set increases, a third set Xₑ^{↑} that contribute to increasing the exposure factor as the value of the third set increases, and a fourth set Xₑ^{↓} that contribute to decreasing the exposure factor as the value of the fourth set increases. In some example embodiments, the first set, the second set, the third set and the fourth set of variables are defined, respectively, as follows:

$${X}_{l}^{↑} = \{ X ∈ {X}_{l} \vert ( {∀}_{{v}_{1} {v}_{2}} ∈ V ) ( ( X ( {v}_{1} ) \leq X ( {v}_{2} ) Λ ( ( ∀ {X}^{′} ∈ χ ∖ \{ X \} ) ( X ( {v}_{1} ) = X ( {v}_{2} ) ) ) ) ⇒ ρ ( {v}_{1} ) \leq ρ ( {v}_{2} ) ) \} ;$$

$${X}_{l}^{↓} = \{ X ∈ {X}_{l} \vert ( {∀}_{{v}_{1} {v}_{2}} ∈ V ) ( ( X ( {v}_{1} ) \leq X ( {v}_{2} ) Λ ( ( ∀ {X}^{′} ∈ χ ∖ \{ X \} ) ( X ( {v}_{1} ) = X ( {v}_{2} ) ) ) ) ⇒ ρ ( {v}_{1} ) \geq ρ ( {v}_{2} ) ) \} ;$$

$${X}_{e}^{↑} = \{ X ∈ {X}_{e} \vert ( {∀}_{{v}_{1} {v}_{2}} ∈ V ) ( ( X ( {v}_{1} ) \leq X ( {v}_{2} ) Λ ( ( ∀ {X}^{′} ∈ χ ∖ \{ X \} ) ( X ( {v}_{1} ) = X ( {v}_{2} ) ) ) ) ⇒ ef ( {v}_{1} ) \leq ef ( {v}_{2} ) ) \} ;$$

$$and$$

$${X}_{e}^{↓} = \{ X ∈ {X}_{e} \vert ( {∀}_{{v}_{1} {v}_{2}} ∈ V ) ( ( X ( {v}_{1} ) \leq X ( {v}_{2} ) Λ ( ( ∀ {X}^{′} ∈ χ ∖ \{ X \} ) ( X ( {v}_{1} ) = X ( {v}_{2} ) ) ) ) ⇒ ef ( {v}_{1} ) \leq ef ( {v}_{2} ) ) \} ,$$

where X is a variable, V is a set of all know vulnerabilities and v is a known vulnerability, ρ(v) is the likelihood of exploitation of the vulnerability v and ef(v) is the exposure factor of the vulnerability v.

In some example embodiments, the likelihood ρ(v) of exploitation of each vulnerability is defined as a function ρ: V→[0,1] as follows:

$$ρ ( v ) = {\prod }_{X ∈ {X}_{l}^{↑}} ( 1 - {e}^{- {α}_{x} \cdot {f}_{x} ( X ( v )} ) / {\prod }_{X ∈ {X}_{l}^{↓}} {e}^{{β}_{x} \cdot {f}_{x} ( X ( v ) )}$$

and the exposure factor ef(v) associated with exploitation of each vulnerability is defined as a function ef: V→[0,1] as follows:

$$ef ( v ) = {\prod }_{X ∈ {X}_{e}^{↑}} ( 1 - {e}^{- {α}_{x} \cdot {f}_{x} ( X ( v )} ) / {\prod }_{X ∈ {X}_{e}^{↓}} {e}^{{β}_{x} \cdot {f}_{x} ( X ( v ) )}$$

where X is the variable, αₓ is atunable parameter, X(v) is the value of X for v, and ƒₓ is a monotonically increasing function used to convert values of X to scalar values, i.e., x1<x2⇒ƒₓ(x1)≤ƒₓ(x2).

In some example embodiments, variables in the first set Xₗ^{↑} comprise at least an exploitability score of a vulnerability as captured by CVSS, time lapsed since publication of details about the vulnerability and a set of known vulnerability exploitations, wherein variables in the second set Xₗ^{↓} comprise at least a set of known IDS rules associated with a vulnerability and a set of vulnerability scanning plugins, wherein variables in the third set Xₑ^{↑} comprise at least an impact score of a vulnerability as captured by Common Vulnerability Scoring System (CVSS), and wherein variables in the fourth set Xₑ^{↓} comprise a set of deployed IDS rules associated with a vulnerability. In some example embodiments, the at least one variable comprises a plurality variables and each of the first set Xₗ^{↑}, the second set Xₗ^{↓}, the third set Xₑ^{↑}, or the fourth set Xₑ^{↓} includes at least one of the plurality of variables, and the method further comprises: providing a quality score of each customized rank; and determining the target vulnerability based at least in part on the quality score.

In some example embodiments, the quality score improves based on an increase in a number of the plurality of variables used in the calculation of the customized metrics. In some example embodiments, the method further includes: adding one or more new variables to at least one of the first set Xₗ^{↑}, the second set Xₗ^{↓}, the third set Xₑ^{↑} or the fourth set Xₑ^{↓} based on a user selection in accordance with the priorities of the distributed system. In some example embodiments, the method further includes: calculating severity scores for the one or more vulnerabilities based on the customized metrics, quality scores of respective customized ranks, and deviations of each customized rank from an ideal scenario in which each vulnerability has a unique severity score; and outputting the severity scores, the quality scores, the deviations and cumulative number of vulnerabilities in each rank on a graphical user interface.

In some example embodiments, the likelihood of exploitation and the exposure factor are combined into a severity score that allows ranking of the one or more vulnerabilities, the severity score is defined as s(v)=ρ(v)·ef(v), the quality score is defined as Q(r)=e^{-γ·δ}(r), and the ideal scenario is defines as δ(r)={square root over (Σᵢ₌₁^{r}(|CVE(r)|−1)²/r)},

where v is a vulnerability, ρ(v) is a likelihood of exploitation of the vulnerability, and ef(v) is an exposure factor of the exploitation of the vulnerability, γ is a tunable parameter and r is a rank, CVE denotes Common Vulnerability Exposures. In some example embodiments, the performing a prioritized remediation of a target vulnerability includes: prioritizing remediation of the one or more vulnerabilities based on the resources available for remediation and current needs of the distributed system; and determining the target vulnerability that poses a greatest risk to the distributed system. In some example embodiments, the types of potential attackers comprises attackers who are aware of only the CVSS scores, attackers who have access to a system component associated with the one or more vulnerabilities, and attackers who can perform reconnaissance on the distributed system and discover unpatched vulnerabilities.

Another embodiment provides a customized vulnerability ranking and scoring system including a customized security risk remediator and a user interface coupled to the customized security risk remediator and structured to receive the user input and output security weakness rankings including the customized rankings periodically or on demand. The customized security risk remediator includes a data ingestion device communicatively coupled to information sources and obtains security data from the information sources, the information sources including at least vulnerability database, Intrusion Detection System (IDS) rules repositories, and vulnerability scanners; a ranking device structured to receive the security data and structured to output security weakness rankings periodically or on demand; a metrics calculator structured to calculate metrics including a likelihood of exploitation of each vulnerability and an exposure factor associated with exploitation of each vulnerability; a metrics customizer structured to customize the metrics based on a user input including at least one variable for use in the calculation, the at least one variable influencing the likelihood of exploitation or the exposure factor and capturing specific applicative domain of each vulnerability, priorities of the distributed system and/or types of potential attackers; and a target security risk remediation device structured to perform a prioritized remediation of a target vulnerability selected by a user from the one or more vulnerabilities based on the customized ranking and specific needs and resources of the distributed system.

In some example embodiments, the at least one variable belongs to a first set Xₗ^{↑} of variables that contribute to increasing the likelihood of exploitation as the value of the first set increases, a second set Xₗ^{↓} that contribute to decreasing the likelihood of exploitation as the value of the second set increases, a third set Xₑ^{↑} that contribute to increasing the exposure factor as the value of the third set increases, and a fourth set Xₑ^{↓} that contribute to decreasing the exposure factor as the value of the fourth set increases. In some example embodiments, the first set, the second set, the third set and the fourth set of variables are defined, respectively, as follows:

$${X}_{l}^{↑} = \{ X ∈ {X}_{l} \vert ( {∀}_{{v}_{1} {v}_{2}} ∈ V ) ( ( X ( {v}_{1} ) \leq X ( {v}_{2} ) Λ ( ( ∀ {X}^{′} ∈ χ ∖ \{ X \} ) ( X ( {v}_{1} ) = X ( {v}_{2} ) ) ) ) ⇒ ρ ( {v}_{1} ) \leq ρ ( {v}_{2} ) ) \} ;$$

$${X}_{l}^{↓} = \{ X ∈ {X}_{l} \vert ( {∀}_{{v}_{1} {v}_{2}} ∈ V ) ( ( X ( {v}_{1} ) \leq X ( {v}_{2} ) Λ ( ( ∀ {X}^{′} ∈ χ ∖ \{ X \} ) ( X ( {v}_{1} ) = X ( {v}_{2} ) ) ) ) ⇒ ρ ( {v}_{1} ) \geq ρ ( {v}_{2} ) ) \} ;$$

$${X}_{e}^{↑} = \{ X ∈ {X}_{e} \vert ( {∀}_{{v}_{1} {v}_{2}} ∈ V ) ( ( X ( {v}_{1} ) \leq X ( {v}_{2} ) Λ ( ( ∀ {X}^{′} ∈ χ ∖ \{ X \} ) ( X ( {v}_{1} ) = X ( {v}_{2} ) ) ) ) ⇒ ef ( {v}_{1} ) \leq ef ( {v}_{2} ) ) \} ;$$

$$and$$

$${X}_{e}^{↓} = \{ X ∈ {X}_{e} \vert ( {∀}_{{v}_{1} {v}_{2}} ∈ V ) ( ( X ( {v}_{1} ) \leq X ( {v}_{2} ) Λ ( ( ∀ {X}^{′} ∈ χ ∖ \{ X \} ) ( X ( {v}_{1} ) = X ( {v}_{2} ) ) ) ) ⇒ ef ( {v}_{1} ) \leq ef ( {v}_{2} ) ) \} ,$$

where X is a variable, Vis a set of all know vulnerabilities and v is a known vulnerability, ρ(v) is the likelihood of exploitation of the vulnerability v and ef(v) is the exposure factor of the vulnerability v.

In some example embodiments, the likelihood ρ(v) of exploitation of each vulnerability is defined as a function ρ: V→[0,1] as follows:

$$ρ ( v ) = {\prod }_{X ∈ {X}_{l}^{↑}} ( 1 - {e}^{- {α}_{x} \cdot {f}_{x} ( X ( v )} ) / {\prod }_{X ∈ {X}_{e}^{↓}} {e}^{{β}_{x} \cdot {f}_{x} ( X ( v ) )}$$

and the exposure factor ef(v) associated with exploitation of each vulnerability is defined as a function ef: V→[0,1] as follows:

$$ef ( v ) = {\prod }_{X ∈ {X}_{e}^{↑}} ( 1 - {e}^{- {α}_{x} \cdot {f}_{x} ( X ( v )} ) / {\prod }_{X ∈ {X}_{e}^{↓}} {e}^{{β}_{x} \cdot {f}_{x} ( X ( v ) )}$$

where X is the variable, αₓ is atunable parameter, X(v) is the value of X for v, and ƒₓ is a monotonically increasing function used to convert values of X to scalar values, i.e., x1<x2⇒ƒₓ(x₁)≤ƒₓ(x₂).

In some example embodiments, variables in the first set Xₗ^{↑} comprise at least an exploitability score of a vulnerability as captured by CVSS, time lapsed since publication of details about the vulnerability and a set of known vulnerability exploitations, wherein variables in the second set Xₗ^{↓} comprise at least a set of known IDS rules associated with a vulnerability and a set of vulnerability scanning plugins, wherein variables in the third set Xₑ^{↑} comprise at least an impact score of a vulnerability as captured by Common Vulnerability Scoring System (CVSS), and wherein variables in the fourth set Xₑ^{↓} comprise a set of deployed IDS rules associated with a vulnerability.

In some example embodiments, the system further includes plugins structured to interface with an individual virtual scanner and Application Programming Interfaces structured to interface with third party applications. In some example embodiments, the data ingestion device is further structured to generate and/or ingest vulnerability scanning reports, and the metrics further comprises a common weaknesses score as defined as S(CWEᵢ)=Σ_{vEC(CWE}_{ᵢ}₎|I(v)|·ρ(v)·ef(v), where v is a vulnerability, I(v) is a set of instances of the vulnerability v within the system, CWEᵢ is a Common Weakness Enumeration weakness, C(CWEᵢ) is a set of common vulnerabilities and explores (CVEs) mapped to CWEᵢ, ρ(v) is the likelihood of exploitation of the vulnerability v and ef(v) is the exposure factor of the vulnerability v. In some example embodiments, the prioritized remediation of a target vulnerability is based at least in part on a prioritization of remediations of the one or more vulnerabilities based on the resources available for remediation and current needs of the distributed system and a determination that the target vulnerability that poses a greatest risk to the distributed system.

### BRIEF DESCRIPTION OF THE DRAWINGS

A full understanding of the invention can be gained from the following description of the preferred embodiments when read in conjunction with the accompanying drawings in which:

FIG. 1 illustrates an exemplary network diagram of a distributed system;

FIG. 2 is an exemplary cyber security framework for determining and remediating a target security risk for a distributed system in accordance with a non-limiting, example embodiment of the disclosed concept;

FIGS. 3-5 illustrate seven tables (Tables 4-10) depicting ranking of CVEs in seven different scenarios using one or more variables to be considered in each set of variables Xₗ^{↑}, Xₗ^{↓} and Xₑ^{↑} in accordance with non-limiting, example embodiments of the disclosed concept; and

FIG. 6 is a flow chart for a method of determining a target vulnerability for prioritized remediation based on needs of a distributed system being protected using an exemplary cyber security framework in accordance with a non-limiting, example embodiment of the disclosed concept.

### DETAILED DESCRIPTION OF THE INVENTION

The example embodiments described herein in accordance with the disclosed concept solve the technical problems of the existing cyber security approaches that provide only generalized security assessments based on generalized scores and rankings, which not only fail to bridge the gap between the two levels of abstraction (“vulnerability” and “weakness”), but also are confined to predefined notions of risk and fixed equations and variables to compute numerical scores such that they do not allow users the flexibility to fine-tune the fixed equations or consider new variables. Further, the example embodiments resolve the technical problems of the existing vulnerability scoring systems, such as the Common Vulnerability Scoring System (CVSS), that often result in a scoring granularity issue where multiple vulnerabilities are assigned the same severity score and thus share the same rank. This failure to provide distinct ranks for each vulnerability hinders the ability to accurately differentiate the severity between distinct vulnerabilities, and thus complicates the prioritization and mitigation processes, thereby negatively impacting targeted response strategies and ultimately leaving the systems at risk due to the potential oversight of critical vulnerabilities that can be exploited by malicious actors.

The example embodiments of the disclosed concept solve these technical problems by providing a cyber security framework for measuring and scoring vulnerabilities, which is uniquely designed to adapt to various application domains and provide a dynamic approach where users can create and modify vulnerability evaluations based on specific scenarios. This customization enhances both the relevance and accuracy of assessments. The core innovation lies in the framework's ability to allow users to customize scoring equations, enabling them to reflect unique operational environments and specific security needs comprehensively. By incorporating extensive details about each vulnerability, the inventive framework facilitates the consideration of multiple dimensions that influence the severity score. The inventive framework ensures that each vulnerability receives a distinct ranking, effectively eliminating the problem of multiple vulnerabilities sharing the same rank. The capability to customize and refine the scoring process based on detailed vulnerability attributes allows for precise vulnerability prioritization in accordance with the needs of a specific distributed system being protected.

This tailored approach according to the disclosed concept not only improves the accuracy of vulnerability assessments but also enhances the effectiveness of prioritization efforts. Security engineers can now address the most critical vulnerabilities with precision, supported by a ranking system provided by the inventive framework that uniquely classifies each vulnerability based on its specific characteristics and the environment's particular security requirements. This invention revolutionizes vulnerability analysis, providing a flexible, customizable, and detailed tool that significantly improves the prioritization and mitigation of potential security threats in any given environment.

As used herein, the singular form of “a”, “an”, and “the” include plural references unless the context clearly dictates otherwise.

As used herein, the statement that two or more parts or components are “coupled” shall mean that the parts are joined or operate together either directly or indirectly, i.e., through one or more intermediate parts or components, so long as a link occurs.

As used herein, “directly coupled” means that two elements are directly in contact with each other.

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

The disclosed concept will now be described, for purposes of explanation, in connection with numerous specific details in order to provide a thorough understanding of the subject innovation. It will be evident, however, that the disclosed concept can be practiced without these specific details without departing from the spirit and scope of this innovation.

The embodiments described herein provide an improvement to a security weakness scoring system (hereinafter referred to as “Mason Vulnerability Scoring Framework” or “MVSF”), which expanded upon the vulnerability metrics for graph-based configuration security as described in U.S. Pat. No. 11,930,046 issued to Albanese et al, by aggregating vulnerability-level metrics to compute weakness-level scores and enable ranking of common weaknesses. The MVSF publishes monthly CWE ranking categories based on a standard parameter configuration, but can also generate monthly, weekly, or even daily rankings on demand, based on a user's needs. While it significantly improved the then existing security risks scoring and ranking systems, the MVSF assigns a score to a CWE entry based on a limited number of known CVEs mapped to that CWE, rather than on the specific vulnerabilities that exist in the distributed system being evaluated. The example embodiments of the present disclosure describe an improved cyber security risk scoring framework that allows for determining and remediating a target vulnerability of a distributed system based on prioritization of discovered security risks in accordance with specific needs of the distributed system being protected.

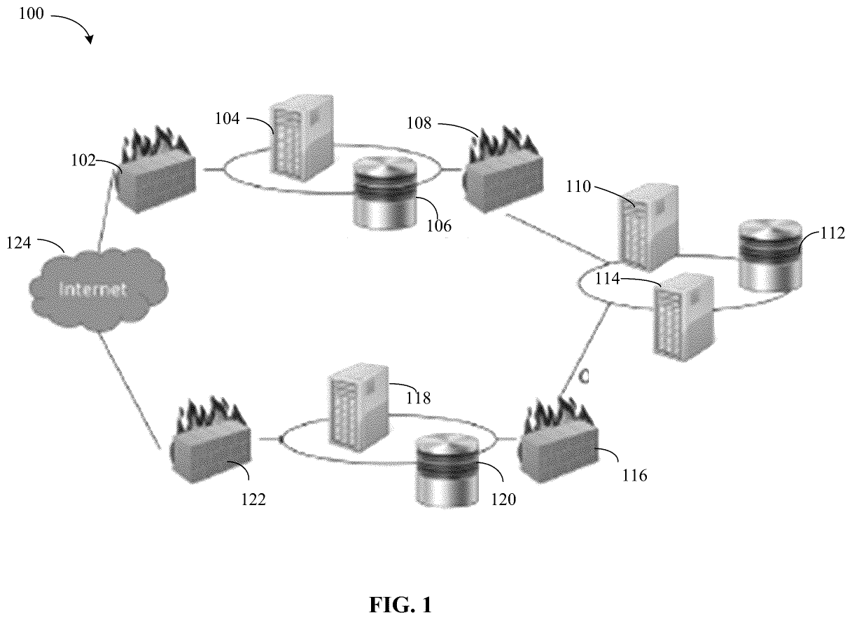

FIG. 1 illustrates an exemplary network diagram 100 of a distributed system. Diagram 100 can include clusters or groups of entities separated by firewalls and connected via a network 124 (e.g., the internet). For example, a first set of entities can include a Web Server 104 (h_{A}) and a Local Database Server 106 (h_{B}). The first set of entities can be separated by a firewall 108 from a second set of entities, which can include a Catalog Server 110 (h_{E}), a Database Server 112 (h_{G}), and an Order Processing Server 114 (h_{F}). The second set of entities can be separated by a firewall 116 from a third set of entities, which can include a Mobile Application Server 118 (h_{C}) and a Local Database Server 120 (h_{D}). The third set of entities can be separated by a firewall 122 from network or internet 124, and the first set of entities can be separated by a firewall 102 from network or internet 124.

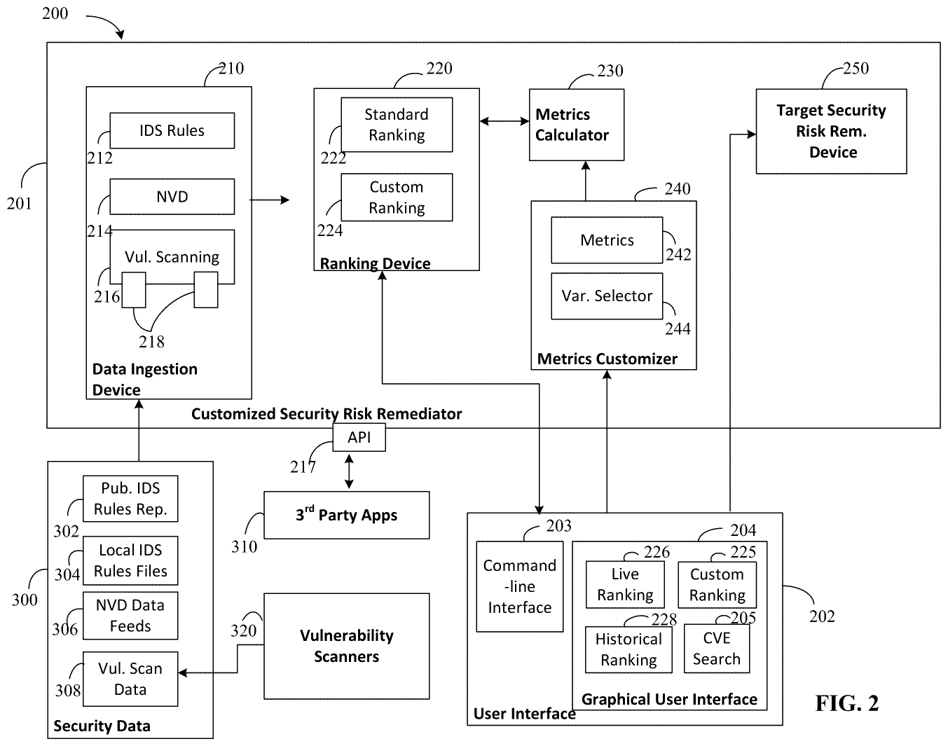

FIG. 2 is an exemplary cyber security framework 200 for determining security weaknesses of the distributed system 100 and performing prioritized remediation of a target security weakness based on user customized metrics and variables in accordance with a non-limiting, example embodiment of the disclosed concept. The term “security weakness” herein includes “weakness” and “vulnerability” of the distributed system 100 and is used interchangeably with the term “security risk” herein. The cyber security framework 200 includes a customized security weakness remediator 201 and a user interface 202. The customized security weakness remediator 201 includes a data ingestion device 210, a ranking device 220, a metrics calculator 230, a metric customizer 240, a target security remediator 250, and an API 217. The user interface 202 includes a command-line interface 203 and a graphical user interface 204. The cyber security framework 200 may be a processing unit that may include a processor and a memory. The processor may be, for example and without limitation, a microprocessor, a microcontroller, or some other suitable processing device or circuitry. The memory can be any of one or more of a variety of types of internal and/or external storage media such as, without limitation, RAM, ROM, EPROM(s), EEPROM(s), FLASH, and the like that provide a storage register, i.e., a machine readable medium, for data storage such as in the fashion of an internal storage area of a computer, and can be volatile memory or nonvolatile memory. The memory may store, e.g., without limitations, standard and customized rankings, metrics and variables for calculating the likelihood (ρ(v)) of vulnerability exploitation and the exposure factor (ef(v)). It may also include instructions to perform the functionalities of the components of the customized security risk remediator 201.

The data ingestion device 210 is communicatively coupled to cyber security information sources and structured to obtain security data therefrom. The data ingestion device 210 includes an IDS rules ingestion device 212, NVD (National Vulnerability Database) data ingestion device 214 and a vulnerability scanning data ingestion device 216. The IDS rules ingestion device 212 is communicatively coupled to public or local IDS rule repositories and structured to obtain the IDS rules. The NVD data ingestion device 214 is communicatively coupled to the NVD and structured to receive NVD data. The vulnerability scanning data ingestion device 216 is communicatively coupled to various open-source and commercial vulnerability scanners (e.g., without limitation, Nessus®, OpenWAS) 320 via APIs (Application Programming Interfaces) 217 and structured to obtain vulnerability scanning data 308. The vulnerability scanning data ingestion device 216 is further structured to generate vulnerability scanning reports based on the vulnerability scanning data. The vulnerability scanning data ingestion device 216 includes a common core and a set of configurable plugins 218 to interface with the various vulnerability scanners 320. The configurable plugins 218 include individual plugins each structured to interface with respective vulnerability scanners. Each individual plugin can be adapted to the functionalities of the respective vulnerability scanners and any change thereof. As such, the configurable plugins 218 allows the data ingestion device 210 to adapt to the current functionalities and limitations of the vulnerability scanners, and thus provide a more complete data ingestion as compared to data collecting mechanisms of the conventional cyber security systems use a common plugin. The APIs 217 are structured to allow third-party applications to integrate within the cyber security framework 200. The APIs of vulnerability scanners 320, upon which the data ingestion device 210 rely, may change over time with little or no advance notice. The APIs 217 mitigate any negative impacts from such change by allowing the data ingestion device 210 to interface with third party applications, and thus reducing reliance on a single vendor and preventing a single point of failure.

While FIG. 2 shows the data ingestion device 210 receiving the security data related to only the IDS rules, NVD and vulnerability scan data 308, that is for illustrative purposes only, and thus any other security data that a user deems appropriate may be obtained and/or utilized in determining security weaknesses and preforming prioritized remediation of the security weaknesses. As such, unlike the existing scoring approaches that require vulnerability assessment based on a predefined set of metrics (e.g., without limitation, Modified Attack Vector (MAV), Modified Privileges Required (MPR)), the cyber security framework 200 allows a user (e.g., without limitations, an administrator, security engineer, security personnel of the cyber security framework 200) to utilize any publicly or otherwise readily available security data that can be mapped to individual CVEs (e.g., without limitation, IDS rules, exploits) with minimal user effort. This in turn allows the user to include new and additional variables to be used in calculation of metrics including, e.g., without limitation, a likelihood (ρ(v)) of vulnerability exploitation and an exposure factor (ef(v)) of a system component to a vulnerability, thereby enabling the user to customize the metrics, refine vulnerability rankings and prioritize the vulnerabilities discovered based on the specific needs and resources of the distributed system 100.

Further, the cyber security framework 200 distinguishes known and deployed IDS rules. A known IDS rule as used herein refers to any IDS rule that is available to the community through publicly accessible repositories. It is assumed that the existence of known IDS rules associated with a given vulnerability may decrease the likelihood of exploiting that vulnerability, as an attacker may prefer to target vulnerabilities that can be exploited without triggering IDS alerts. A deployed IDS rule as used herein refers to any IDS rule that is being actively used by a deployed IDS. Deployed IDS rules may include a subset of known rules or ad hoc rules developed by an administrator of the distributed system 100. An attacker may not be aware of what IDS rules are actually in use, but early detection of intrusions may help mitigate the consequences of an exploit, therefore the cyber security framework 200 accounts for the deployed rules in calculating the vulnerability metrics.

The NVD is the U.S. government repository of standards based vulnerability management data represented using the Security Content Automation Protocol (SCAP), and is maintained by the National Institute of Standards and Technology (NIST). This data enables automation of vulnerability management, security measurement, and compliance. The NVD is built upon and fully synchronized with the Common Vulnerabilities and Exposures (CVE) list of publicly known cybersecurity vulnerabilities. The repository for the CVE is maintained by MITRE and includes various details about each vulnerability, e.g., without limitation, identification number, description, and public references. The NVD augments the CVE list with severity scores, and impact ratings based on the Common Vulnerability Scoring System (CVSS). The CVSS is maintained by the FIRST (Forum of Incident Response and Security Teams) and provides a means to “capture the principal characteristics of a vulnerability and produce a numerical score reflecting its severity.” This score is calculated based on three different metrics: (i) Base Score Metrics; (ii) Temporal Score Metrics; and (iii) Environmental Score Metrics. The cyber security framework 200 utilizes at least the Base Score Metrics for determining security risk scores (system and/or a target security risk). The CVSS Base Score is calculated as follows:

$$BaseScore = ( 0.6 \cdot I + 0.4 \cdot E - 1.5 ) \cdot f ( I ) \qquad EQ . 1$$

where I and E are the Impact and Exploitability scores, as defined by Equations 2 and 3, respectively, and, an ƒ(I) is defined by Eq. 4.

$$I = 10.41 \cdot ( 1 - ( 1 - {I}_{C} ) \cdot ( 1 - {I}_{I} ) \cdot ( 1 - {I}_{A} ) ) \qquad EQ . 2$$

$$E = 20 \cdot AC \cdot A \cdot AV \qquad EQ . 3$$

$$f ( I ) = \{ \begin{matrix}0 , & if I = 0 \\ 1.176 , & otherwise\end{matrix} \qquad EQ . 4$$

The I_{C}, I_{I}, and I_{A} are the confidentiality, integrity and availability impact scores, respectively, as defined in Table 1 below. The AC, A, and AV are the exploitability metrics Access Complexity, Authentication, and Access Vector scores as defined in Table 2 below.

TABLE 1
Impact Metrics

| | Confidentiality | Integrity | Availability |
|---|---|---|---|
| | Impact (I_{C}) | Impact ((I_{I}) | Impact (I_{A}) |
| None | 0.000 | 0.000 | 0.000 |
| Partial | 0.275 | 0.275 | 0.275 |
| Complete | 0.665 | 0.660 | 0.660 |

TABLE 2
Exploitability Metrics

| | Access | | | | |
|---|---|---|---|---|---|
| | Compl. (AC) | Authentication (A) | | Access Vector (AV) | |
| High | 0.35 | Multiple | 0.450 | Local | 0.395 |
| Medium | 0.61 | Single | 0.560 | Adjacent | 0.646 |
| Low | 0.71 | None | 0.704 | Network | 1.000 |

Importantly, since all the submetrics involved in their computation can assume one of only a few discrete values, the Impact and Exploitability scores will also have one of a limited number of discrete values. Thus, ranking thousands of vulnerabilities based on their CVSS scores is impractical. Further, as discussed with reference to the metrics customizer 240, while the cyber security framework 200 utilizes the CVSS Exploitability and Impact scores for determining the vulnerability scores, the cyber security framework 200 also allows the user to use any other cyber environmental variables and/or metrics (if defined by the user) as additional variables deemed appropriate for determining the vulnerability scores.

As previously noted, CWE is a catalogue of weaknesses associated with software, hardware, etc. While a software weakness is not necessarily a vulnerability, but may become a vulnerability. MITRE provides Common Weakness Scoring System (CWSS), a mechanism for prioritizing software weaknesses that are present within software applications. The CWSS is organized into three metric groups: Base Finding, Attack Surface, and Environmental groups. Each group includes a plurality of metrics, also known as factors, that are used to compute a CWSS score for a weakness. Each CVE can be mapped to one or more CWE entries and each CWE entry may encompass numerous (sometimes hundreds) different vulnerabilities. The purpose of classifying CVEs into CWE is to provide an easy way to identify specific types of weaknesses and also understand the nature of vulnerabilities. A set of CVEs mapped to each CWE can be defined as follows:

$$C ( {CWE}_{i} ) = \{ {CVE}_{i} ∈ NVD , {CVE}_{j} \to {CWE}_{i} \} \qquad EQ . 5$$

A number of times each CWE is mapped to a CVE entry is defined as:

$$Freqs = \{ \vert C ( {CWE}_{i} \vert , {CWE}_{i} ϵ NVD \} \qquad EQ . 6$$

Then, the frequency (Fr(CWEᵢ)) and severity (Sv(CWEᵢ)) of a CWE, where the severity is based on the average CVSS score, are computed as follows:

$$Fr ( {CWE}_{i} ) = \vert C ( {CWE}_{i} ) \vert - min ( Freq ) / max ( Freq ) - min ( Freq ) \qquad EQ . 7$$

$$Sv ( {CWE}_{i} ) = {avg}_{{CWE}_{i …}} ( CVSS ) - min ( CVSS ) / max ( CVSS ) - min ( CVSS ) \qquad EQ . 8$$

Then, the overall score of a CWE can be defined as the product of its frequency and severity, normalized between 0 and 100 as follows:

$$Score ( {CWE}_{i} ) = Fr ( {CWE}_{i} ) \cdot Sv ( {CWE}_{i} ) \cdot 100 \qquad EQ . 9$$

Referring back to FIG. 2, the ranking device 220 includes a standard ranking device 222 and a custom ranking device 224. The standard ranking device 222 is structured to generate standard rankings at periodic intervals (e.g., without limitation, monthly, weekly, daily, hourly, etc.) using standard metrics in accordance with the EQs. 5-9. Standard rankings may include standard security weakness rankings including, e.g., without limitation, CWE rankings and vulnerability scoring for current security risk landscape. The custom ranking device 224 is structured to receive a user input to generate a customized ranking based on customized metrics and trigger the metrics calculator 230 to calculate the customized metrics, not the standards metrics. The customized metrics are discussed in further detail with reference to the metrics customizer 240. The customized ranking includes customized security weakness rankings including, e.g., without limitation, CWE rankings and/or vulnerability scorings calculated using the customized metrics. The rankings generated by the ranking device 230 at periodic intervals or on demand provide increased efficiency and convenience to the user as compared to the conventional security weaknesses rankings and scores. For example, the standard rankings 222 are generated at much shorter periodic intervals than the conventional rankings that are produced in, e.g., without limitations, a 24-month period. Further, unlike the conventional CWE rankings or vulnerability scorings that are produced using predefined and fixed variables and metrics, the custom rankings 224 are generated using user selected variables and customized metrics based on the priorities of the distributed system 100 being protected.

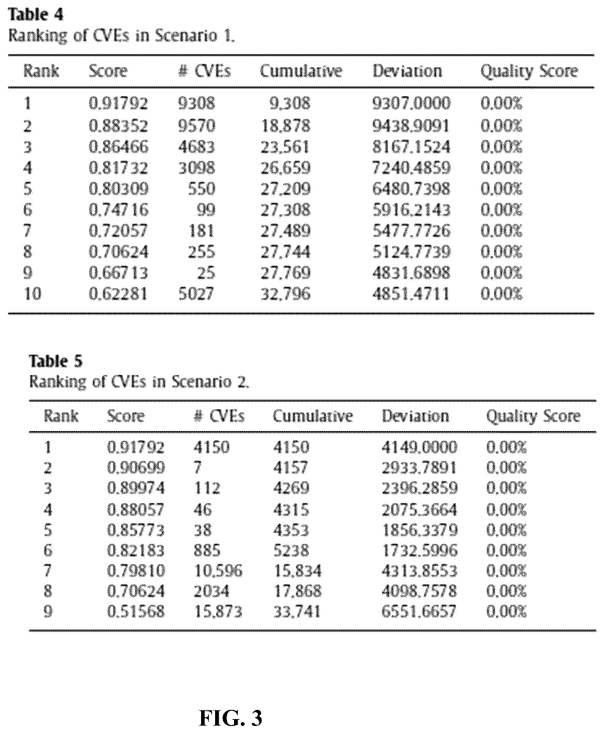

The metrics calculator 230 is structured to receive a signal from the ranking device 220 and calculate a security weakness ranking. For example, if the signal is an automated signal triggered at predefined intervals (e.g., without limitation, monthly, weekly, daily, etc.) from the standard ranking device 222, the metrics calculator 230 calculates the security weakness ranking using the standard metrics as set forth in Equations 5-9. If the signal is a user request received by the custom ranking device 224 to customize the metrics based on one or more variables selected by the user, the metrics calculator 230 calculates the customized ranking using the selected variables as defined in EQs. 10-13 enumerated in FIG. 3. Upon calculating the security weakness ranking, the metrics calculator 230 transmits the ranking to the ranking device 220, which in turn transmits the ranking to the user interface 202 for displaying, e.g., on a screen of a user device (e.g., a PC, a workstation, a mobile computing device, etc.).

The metrics customizer 240 is structured to receive a user input for customizing security weakness rankings. The metrics customizer 240 includes metrics 242 and a variable selector 244. The metrics 242 may include the standard metrics and the customized metrics. The standard metrics may include a new common weakness scoring metric that computes values specific for the distributed system 100 being monitored based on the ingested data, as opposed to the generic scores of common weaknesses computed using average likelihood and average exposure factor by either MITRE or the MVSF, which only consider data from the preceding two years. The generic common weakness score metrics is defined as follows:

$$S ( {CWE}_{i} ) = \vert C ( {CWE}_{i} ) \vert \cdot {avg}_{v ∈ C ( {CWE}_{i} )} ρ ( v ) \cdot {avg}_{v ∈ C ( {CWE}_{i} )} ef ( v ) \qquad EQ . 14$$

where CWEᵢ is a Common Weakness Enumeration weakness, C (CWEᵢ) is a set of common vulnerabilities and explores (CVEs) mapped to CWEᵢ, ρ(v) is a likelihood of exploitation of a vulnerability v and ef(v) is the exposure factor of the vulnerability v. Such generic scores result in several limitations. For example, if one or more vulnerabilities having average or higher-than-average likelihood and/or exposure factor are mapped to CWEᵢ and the mapped one or more vulnerabilities are not present in the distributed system 100 being evaluated, the score assigned to the CWEᵢ based on the generic scores would result in an overestimate of the actual severity thereof. In another example, if one or more vulnerabilities having average or higher-than-average likelihood and/or exposure factor are mapped to CWEᵢ and the mapped one or more vulnerabilities, which are older than the preceding two years, are present in the distributed system 100 being evaluated, the score assigned to the CWEᵢ based on the generic scores would result in an underestimate of the actual severity thereof. In yet another example, if one or more vulnerabilities mapped to CWEᵢ are present on a plurality of hosts within the distributed system 100 being evaluated, the score assigned to the CWEᵢ based on the generic scores would result in an underestimate of the actual severity thereof since the generic scores ignore the fact that an attacker has a plurality of opportunities to exploit the same vulnerabilities. In response to these limitations, the cyber security framework 200 provides a new metric for scoring common weaknesses as defined as follows:

$$S ( {CWE}_{i} ) = {\sum }_{v ∈ C ( {CWE}_{i} )} \vert I ( v ) \vert \cdot ρ ( v ) \cdot ef ( v ) \qquad EQ . 15$$

where I(v) is a set of instances of the vulnerability v within the system. Hence, the new metric for scoring common weaknesses are not based on the average of likelihood or average exposure factor, thereby allowing the user to consider all vulnerabilities for determining the common weaknesses score of the distributed system 100 regardless of the age of the data.

The customized metrics include two important metrics that are specifically defined by the cyber security system 200. The two metrics are an exploitation likelihood (ρ(v)) of a vulnerability and an exposure factor (ef(v)) of exploitation of the vulnerability. The likelihood (ρ(v)) of vulnerability exploitation is a probability that an attacker will attempt to exploit that vulnerability, if given the opportunity. An attacker has the opportunity to exploit a vulnerability if certain preconditions are met, e.g., without limitation, the attacker having access to a vulnerable host. Specific preconditions may vary depending on the specific characteristics of each vulnerability, as certain configuration settings may prevent access to vulnerable portions of a target software. An exposure factor (ef(v)) refers to a relative loss of utility of an asset due to a vulnerability exploitation. A single loss expectancy (SLE) associated with a successful attack is then computed as the product between its exposure factor (ef(v)) and the asset value (AV), i.e., SLE=EF×AV.

Susceptibility of a vulnerability to becoming an exploitation target by malicious actors depends on a number of variables, including features of the vulnerability itself and characteristics of potential attackers. Unlike the conventional security systems that confine the users with the predefined metrics with predefined notions of risks in fixed attack surfaces, the cyber security framework 100 allows numerous variables to be considered and corresponsive weights to be used in situations involving different types of attackers, e.g., without limitations, ranging from attackers who are only aware of vulnerability's CVSS scores to adversaries that can perform reconnaissance on target systems and discover unpatched vulnerabilities. The cyber security framework 200 allows for the user to assess security risks using any variables that may affect the metrics. V denotes a set of all known vulnerabilities, Xₗ denotes a set of variables that influence the likelihood (ρ(v)) and Xₑ denotes a set of variables that influence the exposure factor (ef(v)). Xₗ^{↑} and Xₗ^{↓} denote the sets of variables that respectively contribute to increasing and decreasing the likelihood (ρ(v)) as their values increase. Xₑ^{↑} and Xₑ^{↓} denote the sets of variables that respectively contribute to increasing and decreasing the exposure factor (ef(v)) as their values increase. The Xₗ^{↑}, Xₗ^{↓}, Xₑ^{↑} and Xₑ^{↓} are defined by Equations 10-13, respectively, as follows:

$$EQ . 10$$

$${X}_{l}^{↑} = \{ X ∈ {X}_{l} \vert ( {∀}_{{v}_{1} {v}_{2}} ∈ V ) ( ( X ( {v}_{1} ) \leq X ( {v}_{2} ) Λ ( ( ∀ {X}^{′} ∈ χ ∖ \{ X \} ) ( X ( {v}_{1} ) = X ( {v}_{2} ) ) ) ) ⇒ ρ ( {v}_{1} ) \leq ρ ( {v}_{2} ) ) \}$$

$$EQ . 11$$

$${X}_{l}^{↓} = \{ X ∈ {X}_{l} \vert ( {∀}_{{v}_{1} {v}_{2}} ∈ V ) ( ( X ( {v}_{1} ) \leq X ( {v}_{2} ) Λ ( ( ∀ {X}^{′} ∈ χ ∖ \{ X \} ) ( X ( {v}_{1} ) = X ( {v}_{2} ) ) ) ) ⇒ ρ ( {v}_{1} ) \geq ρ ( {v}_{2} ) ) \}$$

$$EQ . 12$$

$${X}_{e}^{↑} = \{ X ∈ {X}_{e} \vert ( {∀}_{{v}_{1} {v}_{2}} ∈ V ) ( ( X ( {v}_{1} ) \leq X ( {v}_{2} ) Λ ( ( ∀ {X}^{′} ∈ χ ∖ \{ X \} ) ( X ( {v}_{1} ) = X ( {v}_{2} ) ) ) ) ⇒ ef ( {v}_{1} ) \leq ef ( {v}_{2} ) ) \}$$

$$EQ . 13$$

$${X}_{e}^{↓} = \{ X ∈ {X}_{e} \vert ( {∀}_{{v}_{1} {v}_{2}} ∈ V ) ( ( X ( {v}_{1} ) \leq X ( {v}_{2} ) Λ ( ( ∀ {X}^{′} ∈ χ ∖ \{ X \} ) ( X ( {v}_{1} ) = X ( {v}_{2} ) ) ) ) ⇒ ef ( {v}_{1} ) \leq ef ( {v}_{2} ) ) \}$$

Variables in Xₗ^{↑} include, e.g., without limitations, a vulnerability's exploitability score as captured by CVSS, time lapsed since publication of details about a vulnerability, and a set of known exploits. The CVSS Exploitability score captures how easy it is to exploit a vulnerability, based on different features captured by various sub-metrics, most notably Access Vector (AV) and Access Complexity (AC). The Access Vector metric reflects the context in which a vulnerability can be exploited. Its value is higher for vulnerabilities that can be exploited remotely, and are therefore more likely to be exploited as the number of potential attackers is larger than the number of potential attackers that could exploit a vulnerability requiring physical access to the vulnerable host. The Attack Complexity metric reflects the amount of effort and resources required for a successful attack. Its value is higher for exploits that require little or no effort, and are therefore more likely to be exploited. The time lapsed since the publication of the details of a vulnerability passed plays a role in determining the likelihood (ρ(v)). For example, the longer a vulnerability has been known, the more exploits may have been developed by the hacker community. While it is true that the likelihood that patches have been developed also increases with time, it is well-known that patches are not applied promptly and consistently across systems, thus giving attackers a window of opportunity to target known but unpatched vulnerabilities. The set of known exploits and Proofs of Concept (PoCs) associated with a vulnerability can provide an incentive for attackers to exploit specific vulnerabilities.

Variables in Xₗ^{↓} include, e.g., without limitations, a set of known IDS rules associated with a vulnerability and a set of vulnerability scanning plugins. Known IDS rules may influence the attacker's choice of vulnerabilities to exploit. With systems typically exposing multiple vulnerabilities, attackers may choose to avoid exploits that are more easily detectable. Vulnerability scanning tools can provide an inventory of existing system vulnerabilities. The availability of plugins to confirm the existence of a given vulnerability may make such vulnerability less likely to be exploited because attackers may expect that defenders would use such detection capabilities to detect and mitigate that vulnerability.

Variables in Xₑ^{↑} include, e.g., without limitations, a vulnerability's impact score as captured by CVSS. As previous mentioned, the CVSS Impact score captures the impact of a vulnerability exploit on confidentiality, integrity, and availability.

Variables in Xₑ^{↓} include, e.g., without limitations, a set of deployed IDS rules associated with a vulnerability. IDS rules that are deployed on a distributed system 100 and actively monitoring for intrusions can mitigate the consequences of an exploit through timely detection.

It will be understood that the variables presented herein are for illustrative purposes only, and thus can include any other variables that may be identified and used in the calculation of both the likelihood (ρ(v)) and the exposure factor (ef(v)). For instance, it has been shown that the likelihood (ρ(v)) also depends on the position of a vulnerable system within an attack path. In fact, a vulnerability on a perimeter network may be more likely to be exploited than the same vulnerability on an internal network. Additionally, vulnerabilities that have similar characteristics as those an attacker has already exploited might be more easily exploited as compared to completely different vulnerabilities.

The cyber security framework 200 defines the likelihood (ρ(v)) as a function ρ: V→[0,1] as follows:

$$ρ ( v ) = {\prod }_{X ∈ {X}_{l}^{↑}} ( 1 - {e}^{- {α}_{x} \cdot {f}_{x} ( X ( v )} ) / {\prod }_{X ∈ {X}_{e}^{↓}} {e}^{{β}_{x} \cdot {f}_{x} ( X ( v ) )} \qquad EQ . 16$$

Each variable contributes to the overall likelihood as a multiplicative factor between 0 and 1 that is formulated to account for diminishing returns. Factors corresponding to variables in Xₗ^{↑} are of the form 1-e^{α}^{ₓ}^{·ƒ}^{ₓ}^{(x(v)}, where X is the variable, αₓ is atunable parameter, X(v) is the value of X for v, and ƒₓ is a monotonically increasing function used to convert values of X to scalar values, i.e., x1<x2⇒ƒₓ(x₁)≤ƒₓ(x₂). Similarly, factors corresponding to variables in Xₗ^{↓} are of the form 1/e_{β}_{^{x}}_{·ƒ}_{^{x}}_{(X(v))}=e^{-B}^{ₓ}^{·ƒ}^{ₓ}^{(X(v))}. It is assumed that that each product evaluates to 1 when the corresponding set of variables is empty, i.e., Π_{X∈X}( . . . )=1 when X=0. The definition of the function ƒₓ implies that the domain of each variable is a totally ordered set. While not every domain may be a totally order set, it is possible to map elements of the domain to elements of a totally ordered set. For instance, if the values of a variable are sets of objects, their respective cardinalities are totally ordered. If the function mapping the values of a variable X to values of a totally ordered set is a scalar function, then it can be used as the function ƒₓ in EQ. 16. In most cases, when the values of X are already scalar values, ƒₓ can be defined as the identity function ƒₓ(x)=x, but in the case of the time t since the vulnerability was disclosed, ƒₓ(t)=\sqrt{t} to model a less-than-linear relationship.

The cyber security framework 200 defines the exposure factor as a function ef: V→[0,1] as follows:

$$ef ( v ) = {\prod }_{X ∈ {X}_{e}^{↑}} ( 1 - {e}^{- {α}_{x} \cdot {f}_{x} ( X ( v )} ) / {\prod }_{X ∈ {X}_{e}^{↓}} {e}^{{β}_{x} \cdot {f}_{x} ( X ( v ) )} \qquad EQ . 17$$

Similar to the likelihood (ρ(v)), each variable contributes to the exposure factor as a multiplicative factor between 0 and 1 that accounts for diminishing returns. Factors corresponding to variables in Xₑ^{↑} are of the form 1-e^{α}^{ₓ}^{·ƒ}^{ₓ}^{(x(v)}, and factors corresponding to variables in Xₑ^{↓} are of the form 1/e_{β}_{^{x}}_{·ƒ}_{^{x}}_{(X(v))}=e^{-β}^{ₓ}^{·ƒ}^{ₓ}^{(X(v))}. It is assumed that that each product evaluates to 1 when the corresponding set of variables is empty, i.e., Π_{X∈X}( . . . )=1 when X=0.

Referring back to FIG. 2, the variable selector 244 is structured to receive a user input including one or more variables selected for customizing the metrics 242. The one or more variables may be included in a list of variables stored in a memory. The user may update and/or add new variables as deemed appropriate in accordance with the needs and priorities of the distributed system 100. Upon receiving the one or more variables selected and/or added by the user, the metrics customizer 244 customizes the metrics as set forth in the EQs. 10-17 and transmits the customized metrics to the metrics calculator 230. The metrics calculator 230 calculates the customized metrics and the customized ranking of one or more vulnerabilities discovered in the distributed system 100. The custom ranking device 224 then outputs the customized ranking. The target security risk remediation device 250 is structured to perform a prioritized remediation of a target vulnerability based on a user command.

The user interface 202 includes a command-line interface 203 and a graphical user interface 204. The command-line interface 203 may include a keyboards, a keypad, and/or other non-graphical user interface via which the user may provide a user input or command. The graphical user interface may include, e.g., without limitation, a display or touch screen via which the user may view various security data including customized ranking 225, live ranking 226, historical ranking 228, perform data search, e.g., without limitation, CVE search 205, and interact with the customized security risk remediator 201 via the graphical user interface 204.

In operation, the data ingestion device 210 receives security data from information sources. Based on the security data, the standard ranking device 222 provides standard security weakness rankings using standard metrics at predefined periodic intervals. In some example embodiments, the data ingestion device 210 may trigger the ranking device 220 to provide the rankings upon receipt of the security data. The user reviews the standard rankings and determines that one or more vulnerabilities exist in one or more system components of the distributed system 100. In some example embodiments, the cyber security framework 200 may determine that one or more vulnerabilities exist in one or more system components of the distributed system 100 based on the security data and the standard rankings and alert the user about the discovered one or more vulnerabilities. The user reviews the one or more vulnerabilities and customizes metrics for calculating a likelihood of exploitation of each vulnerability and an exposure factor associated with an exploited vulnerability by selecting variables based on a specific applicative domain of each vulnerability, resources and priorities of the distributed system 100 being protected and types of potential attackers. The cyber security framework 200 receives a user request for a customized ranking of the one or more vulnerabilities based on the customized metrics. The custom ranking device 224 receives the user request and triggers the metrics calculator 230 to calculate the customized metrics based on the one or more variables. The metrics calculator 230 calculates the customized metrics using the one or more variables, severity scores for the one or more vulnerabilities, customized ranks for the one or more vulnerabilities, and respective quality scores of the customized ranks. The custom ranking device 224 provides the customized ranking 225 via the graphical user interface 202. In some example embodiments, the custom ranking device 224 may provide the user the customized ranking 225 as well as at least one of respective vulnerability scores, a number of vulnerabilities sharing each vulnerability scores, cumulative number of vulnerabilities in each ranking, deviation of each rank from the ideal scenario or a quality score for each ranking. The user then reviews the customized ranking 225 and determines a target vulnerability that poses a greatest risk to the distributed system 100 being protected based on priorities and resources of the distributed system 100. The user then provides a user command to the cyber security system 200 to perform remediation of the target vulnerability. The target security risk remediation device 250 then performs the remediation of the target vulnerability.

By defining two critical security metrics, the exploitation likelihood (ρ(v)) and the exposure factor (ef(v)) of a vulnerability of a specific system component and providing general principles for selecting variables by a user, the cyber security system 200 allows the users to instantiate customized metrics that best model a specific attack scenario being considered. Further, the cyber security system 200 provides severity scores of the discovered vulnerabilities based on the combination of the two critical metrics, thereby allowing each vulnerability to be ranked. Such individual rank of each vulnerability then allows the user to improve their ability to discriminate the vulnerabilities with very similar severity levels and isolate those vulnerabilities that pose the greatest risk to their distributed system 100. By providing a plurality of variables that influence the calculation of the two important metrics, the cyber security framework 200 allows the user to consider variables for the metrics tailored to various attack scenarios taking into account the specific applicative domain of the distributed system 100, the priorities and resources thereof as well as the potential attackers' knowledge, skills and resources.

These advantages and benefits have been demonstrated by experiments. Experimental results using the cyber security framework 200 in seven different attack and defense scenarios are now described. The cyber security framework 200 has been validated by aggregating vulnerability-level metrics into a CWE score for each CWE category and the rankings of CWEs calculated by the cyber security framework 200 were then compared against MITRE's CWE Top 25 Most Dangerous Software Weaknesses. The results indicated that when the cyber security framework 200 is tuned to reproduce MITRE's experimental setting as closely as possible, the correlation between the resulting CWE rankings and MITRE's ranking is between 80% and 90%. In each scenario, assumptions about the information available to the attacker were made. It is assumed that any information that is available to the attacker is also available to the defender, but not all information that is available to the defender is also available to the attacker. For instance, both the attacker and the defender are aware of known IDS rules associated with a vulnerability, but only the defender knows which rules are actually deployed within their systems. For the experiments, a severity score of a vulnerability was defined as

$$s ( v ) = ρ ( v ) \cdot ef ( v ) \qquad EQ . 18$$

Each scenario utilizes a different choice of variables for Xₗ^{↑}, Xₗ^{↓}, Xₑ^{↑} and Xₑ^{↓}. Table 3 shows the variables considered in each scenario. As shown in Table 3 below, only one variable was considered for scenarios 1 and 2 and a plurality of variables were considered for scenarios 3-7. The results showed that considering different combinations of variables leads to different rankings of vulnerabilities and increasing the number of variables considered leads to more fine-grained rankings and an improved ability to discriminate between different vulnerabilities while allowing for prioritizing mitigation and remediation. It is to be understood that the variables illustrated in Table 3 are for illustrative purposes only, and thus different variables may be added as appropriate without departing from the scope of the disclosed concept. That is, the users can customize the rankings for their specific environment by adding variables that capture environment-specific information, e.g., without limitations, the sets of IDS rules actually deployed across the system. The results showed that considering different combinations of variables leads to different rankings of vulnerabilities and increasing the number of variables considered leads to more fine-grained rankings and an improved ability to discriminate between different vulnerabilities while allowing for prioritizing mitigation and remediation.

TABLE 3
Variables Considered in Experimental Scenarios

| | Xₗ^{↑} | Xₗ^{↓} | Xₑ^{↑} |
|---|---|---|---|
| Scenario 1 | {CVSS_Exploitability} | 0 | 0 |
| Scenario 2 | 0 | 0 | {CVSS_Impact} |
| Scenario 3 | {CVSS_Exploitability} | 0 | {CVSS_Impact} |
| Scenario 4 | {CVSS_Exploitability} | {Known_IDS_Rules} | {CVSS_Impact} |
| Scenario 5 | {CVSS_Exploitability}, | {Known_IDS_Rules} | {CVSS_Impact} |
| | {Vuln._Exploitation} | | |
| Scenario 6 | {CVSS_Exploitability}, | {Known_IDS_Rules}, | {CVSS_Impact} |
| | {Vuln._Exploittation} | {Vuln_Plugins} | |
| Scenario 7 | {CVSS_Exploitability}, | {Known_IDS_Rules} | {CVSS_Impact} |
| | {Time} | | |
| Scenario 6 | {CVSS_Exploitability}, | {Known_IDS_Rules}, | {CVSS_Impact} |
| | {Vuln._Exploittation} | {Vuln_Plugins} | |
| Scenario 7 | {CVSS_Exploitability}, | {Known_IDS_Rules} | {CVSS_Impact} |
| | {Time} | | |

In scenario 1, the CVSS Exploitability score was considered as the only variable in the set for Xₗ^{↑} as defined by Equation 10. No variables were considered for the other three sets, Xₗ^{↓}, Xₑ^{↑} and Xₑ^{↓}. As such, Equation 16 and 17 can be rewritten as follows:

$$ρ ( v ) = {Π}_{X ∈ \{ {CVSS}_{-} Exploitability \}} ( 1 - {e}^{- {α}_{x} \cdot {f}_{x} ( X ( v )} ) \qquad EQ . 19$$

$$ef ( v ) = 1 \qquad EQ . 20$$

Table 4 in FIG. 3 shows, for each rank r, the value of the severity score, the number of CVEs with that severity score, the cumulative number of vulnerabilities with that or higher severity score, the standard deviation, and the quality score of the partial ranking ending at r. In an ideal scenario, when vulnerabilities are ranked there should be no ties between CVEs, i.e., each CVE should have its unique score. Instead, the table shows that, for each of the top r distinct values of the severity score, there are multiple vulnerabilities (even thousands) with the same score. As shown in the table, the cumulative number of CVEs with one of the top 10 values of the severity score is 32,796 out of the 33,741 considered, which makes this ranking not useful in practice. The quality score, as defined by Eq. 21 below, helps determine how much the ranking deviates from the ideal scenario. This score is an exponential function of the standard deviation between the numbers of vulnerabilities for each rank and a vector of r's corresponding to the ideal scenario as defined by EQ. 22 below.

$$Q ( r ) = {e}^{- γ \cdot δ} ( r ) \qquad EQ . 21$$

$$δ ( r ) = \sqrt{{\sum }_{i = 1}^{r} {( \vert C V E ( r ) \vert - 1 )}^{2} {/}_{r}} \qquad EQ . 22$$

The quality score goes asymptotically to 0 as the standard deviation increases. Scenario 1 shows a high number of CVEs having the same severity score. This results in a high standard deviation and consequently in a virtually 0 quality score. Intuitively. this ranking does not provide significant help for security administrators to make informed decisions when it comes to prioritizing vulnerability remediation. These results can be explained by examining EQ. 3, which defines the exploitability as a function of three variables, each of which can have only 3 possible values, resulting in a maximum of 27 possible values.

In scenario 2, the CVSS impact score was considered as the only variable in the set Xₑ^{↑} as defined by EQ. 10. No variables were considered for other three sets Xₗ^{↑}, Xₗ^{↓} and Xₑ^{↓}. As such, Equations 16 and 17 can be rewritten as follows:

$$ρ ( v ) = 1 \qquad ( EQ . 23 )$$

$$ef ( v ) = {Π}_{X ∈ \{ C V S {S}_{-} Impact \}} ( 1 - {e}^{- {α}_{x} {f}_{x} ( X ( v )} ) \qquad ( EQ . 24 )$$

As shown in in Table 5 of FIG. 3, the quality of the resulting ranking is again practically 0, due to the high number of vulnerabilities with the same score. results can be explained by examining Eq. 2, which defines the impact as a function of three variables, each of which can have only the same 3 possible values, resulting in a maximum of 10 possible values (number of combination with repetition). Thus, the ability of a metric based solely on the CVSS impact score to discriminate among different vulnerabilities is even less than the metric used in the previous scenario, as confirmed by the fact that all 33,741 vulnerabilities considered are assigned one of only 9 different scores.

In scenario 3, the CVSS Exploitability score was considered as the only variable in the set Xₗ^{↑} as defined by EQ. 10 and the CVSS Impact score as the only variable in the set Xₑ^{↑} as defined by EQ. 12. No variables were considered for the other two sets Xₗ^{↓}, and Xₑ^{↓}. As such, Equations 16 and 17 can be rewritten as follows:

$$ρ ( v ) = {Π}_{X ∈ \{ {CVSS}_{E x p l o i t a b i l i t y} \}} ( 1 - {e}^{- {α}_{x} \cdot {f}_{x} ( X ( v )} ) \qquad ( EQ . 25 )$$

$$ef ( v ) = {Π}_{X ∈ \{ C V S {S}_{-} Impact \}} ( 1 - {e}^{- {α}_{x} \cdot {f}_{x} ( X ( v )} ) \qquad ( EQ . 24 )$$

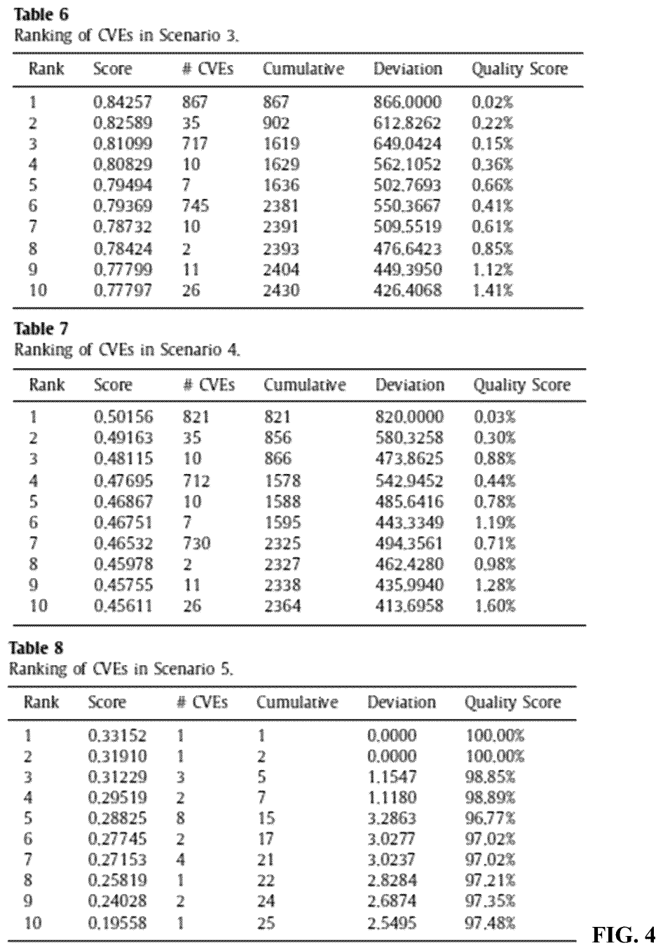

As shown in Table 6 of FIG. 4, the quality of the resulting ranking starts to improve as the combined effect of multiple variables allows to better discriminate between different vulnerabilities, although the ranking is still far from the ideal case. The top 10 values of the severity score now involve “only” 2430 CVEs, an order of magnitude less than the previous 2 scenarios. This scenario is directly comparable to a scenario in which CVSS Base Score is used to rank vulnerabilities. Although the severity score formula used is different from the CVSS Base Score formula, both are ultimately functions of two variables that can assume only a limited number of discrete values, 27 and 10 respectively, thus limiting their ability to provide a useful ranking of vulnerabilities.

In scenario 4, the CVSS Exploitability score as the only variable in the set Xₗ^{↑}, the CVSS Impact score as the only variable in the set Xₑ^{↑}, and a set of known IDS rules as the only variable in the set Xₗ^{↑} were considered with ƒₓ defined as the cardinality of the set of rules. As such, the Equations 16 and 17 can be rewritten as follows:

$$ρ ( v ) = {Π}_{X ∈ \{ CVSS\_Expl o i t a b i l i t y \}} ( 1 - {e}^{- {α}_{x} \cdot {f}_{x} ( X ( v )} ) / {Π}_{X ∈ \{ Known\_IDS \_R \}} {e}^{{β}_{x} \cdot {f}_{x} ( x ( v ) )} \qquad ( EQ . 27 )$$

$$ef ( v ) = {Π}_{X ∈ \{ C V S {S}_{-} Impact \}} ( 1 - {e}^{- {α}_{x} \cdot {f}_{x} ( X ( v )} ) \qquad ( EQ . 24 )$$

As shown in Table 7 of FIG. 4, the quality of the resulting ranking improves slightly as compared to scenario 3. The relatively slight increase is due to the fact that most CVEs have either no or only one associated IDS rule. However, new rules can be defined over time.

In scenario 5, the CVSS Exploitability score and a set of vulnerability exploitations as the variables in the set Xₗ^{↑}, the CVSS Impact score as the only variable in the set Xₑ^{↑}, and a set of known IDS rules as the only variable in the set Xₗ^{↑} were considered with ƒₓ defined as the cardinality of the set of rules. As such, the Equations 16 and 17 can be rewritten as:

$$ρ ( v ) = {Π}_{X ∈ \{ CVSS \_ Expl . , Vul\_Expl . \}} ( 1 - {e}^{- {α}_{x} \cdot {f}_{x} ( X ( v )} ) / {Π}_{X ∈ \{ Known\_IDS \}} {e}^{{β}_{x} \cdot {f}_{x} ( x ( v ) )} \qquad ( EQ . 28 )$$

$$ef ( v ) = {Π}_{X ∈ \{ CVSS \_ Exploitability \}} ( 1 - {e}^{- {α}_{x} \cdot {f}_{x} ( X ( v )} ) \qquad ( EQ . 24 )$$

As shown in Table 8 of FIG. 4, the quality score of the ranking improves significantly, reaching 97% for r=10. For r=2 the quality score is 100% as there is exactly one CVE for each of the top 2 severity scores. This can be explained by considering that vulnerability exploits are publicly available for a relatively small number of vulnerabilities, thus favoring these vulnerabilities over many others. Further, as more variables are considered, the highest severity score becomes smaller. This is expected, as more factors between 0 and 1 are being multiplied.

In scenario 6, the CVSS Exploitability score and a set of vulnerability exploitations as the variables in the set Xₗ^{↑}, the CVSS Impact score as the only variable in the set Xₑ^{↑}, and a set of known IDS rules and a set of vulnerability scanning plugins as the variables in the set Xₑ^{↑} were considered with ƒₓ defined as the cardinality of the set of rules. As such, the Equations 16 and 17 can be rewritten as:

$$ρ ( v ) = {Π}_{X ∈ \{ CVSS \_ Exp . , Vul\_Exp . \}} ( 1 - {e}^{- {α}_{x} \cdot {f}_{x} ( X ( v )} ) / {Π}_{X ∈ \{ Known\_IDS , V\_Plug \}} {e}^{{β}_{x} \cdot {f}_{x} ( x ( v ) )} \qquad ( EQ . 29 )$$

$$ef ( v ) = {Π}_{X ∈ \{ C V S {S}_{-} Impact \}} ( 1 - {e}^{- {α}_{x} \cdot {f}_{x} ( X ( v )} ) \qquad ( EQ . 24 )$$

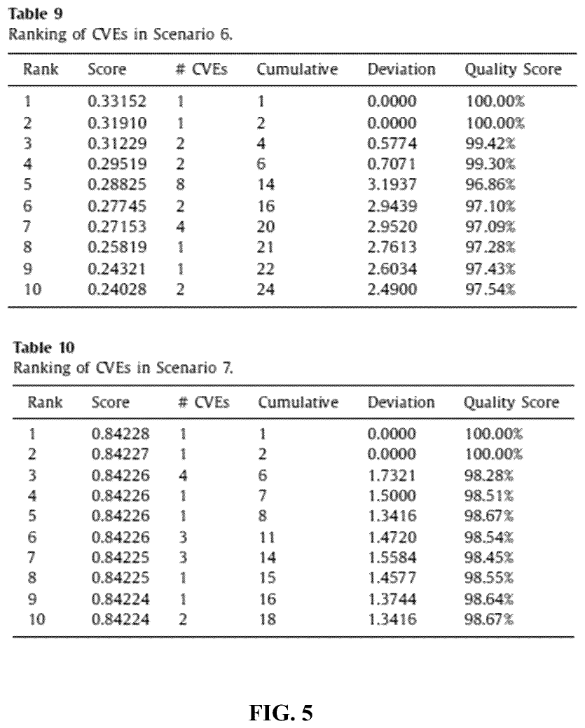

As shown in Table 9 of FIG. 5, the quality score of the ranking improves slightly compared to Scenario 5. The almost negligible improvement may be explained with these two arguments: (i) once the quality score has reached over 95%, additional improvements cannot be expected to be significant due to a diminishing returns effect; and (ii) the vulnerabilities for which the hacker community has developed exploits may be those that vulnerability scanning vendors prioritize in the development of plugins. In other words, if two variables are highly correlated, including both of them in the computation of vulnerability metrics may produce only a slight improvement over scenarios in which only one of them is used.

In scenario 7, the CVSS Exploitability score and the time lapsed since the publication of the details of a vulnerability as the variables in the set Xₗ^{↑}, the CVSS Impact score as the only variable in the set Xₑ^{↑}, and a set of known IDS rules as the only variable in the set Xₗ^{↑} were considered with ƒₓ defined as the cardinality of the set of rules. As such, the Equations 16 and 17 can be rewritten as follows:

$$ρ ( v ) = {Π}_{X ∈ \{ CVSS \_ Exp . , Time \}} ( 1 - {e}^{- {α}_{x} \cdot {f}_{x} ( X ( v )} ) / {Π}_{X ∈ \{ Known\_IDS , V\_Plug \}} {e}^{{β}_{x} \cdot {f}_{x} ( x ( v ) )} \qquad ( EQ . 30 )$$

$$ef ( v ) = {Π}_{X ∈ \{ C V S {S}_{-} Impact \}} ( 1 - {e}^{- {α}_{x} \cdot {f}_{x} ( X ( v )} ) \qquad ( EQ . 24 )$$

As shown in Table 7 of FIG. 5, the quality score of the resulting ranking is comparable to that obtained in the previous two scenarios. Once again, this can be explained by considering that the time lapsed since the publication of the detail of a vulnerability is correlated with the availability of both exploits and plugins. In fact, as the vulnerability ages, more plugins and exploits are developed.

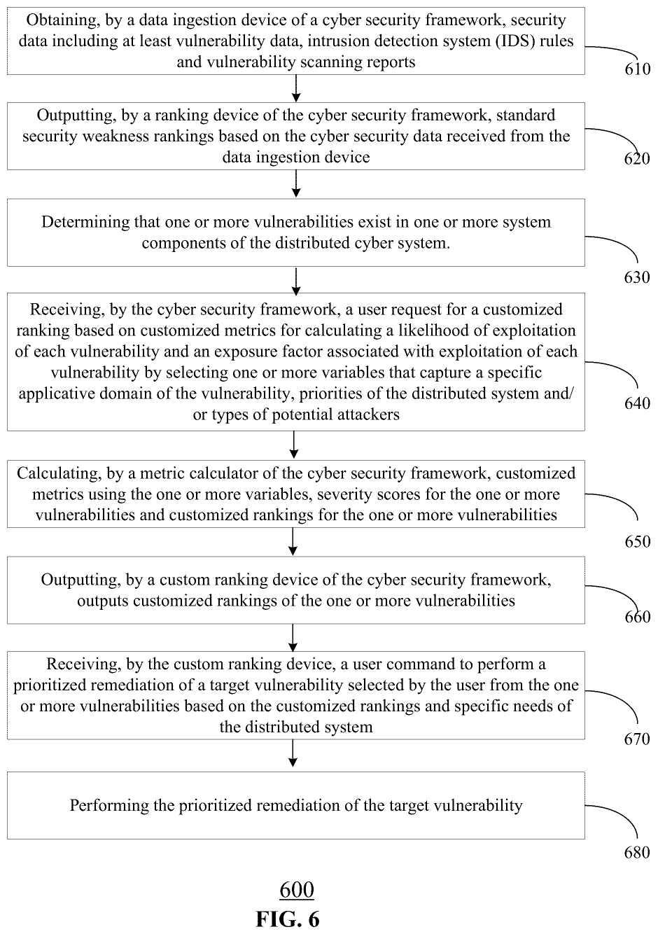

FIG. 6 is a flowchart for a method 600 of determining a target vulnerability for prioritized remediation of a distributed system in accordance with a non-limiting, example embodiment of the disclosed concept. The method 600 may be performed by the cyber security framework 200 (or any components thereof) and/or by a user of the cyber security framework.

At step 610, a data ingestion device of the cyber security framework obtains cyber security data including at least vulnerability data, intrusion detection system (IDS) rules and vulnerability scanning reports.

At step 620, a ranking device of the cyber security framework outputs standard security weakness rankings based on the cyber security data received from the data ingestion device.

At step 630, it is determined that one or more vulnerabilities exist in one or more system components of the distributed system based on the standard security weakness rankings. The user or the cyber security system may determine that one or more vulnerabilities exist. The user may review the standard weakness rankings, and perform analytics via the cyber security system to determine that one or more vulnerabilities exist. Alternatively, the cyber security system may run the analytics on the distributed system and determine that one or more vulnerabilities exits. Based on the determination, the cyber security system may alert the user via a graphical user interface. The user then customizes metrics for calculating a likelihood of exploitation of each vulnerability and an exposure factor associated with the exploitation of each vulnerability by selecting variables based on a specific applicative domain of each vulnerability, resources and priorities of the distributed system being protected and types of potential attackers. The metrics are combined to obtain severity scores of the one or more vulnerabilities and respective customized ranks.

At step 640, the cyber security framework receives a user request for a customized ranking based on customized metrics for calculating a likelihood of exploitation of each vulnerability and an exposure factor associated with exploitation of each vulnerability by selecting one or more variables that capture the specific applicative domain of the vulnerability, priorities of the distributed system and/or types of potential attackers.

At step 650, a metric calculator of the cyber security framework calculates the customized metrics using the one or more variables, severity scores for the one or more vulnerabilities and customized ranks for the one or more vulnerabilities. The metric calculator may also calculate quality scores of the customized ranks.

At step 660, a custom ranking device of the cyber security framework outputs customized ranking of the one or more vulnerabilities. The user may request the severity scores for the one or more vulnerabilities and respective quality scores of the customized ranks. The custom ranking device may also provide the user a number of vulnerabilities sharing each vulnerability score, cumulative number of vulnerabilities in each rank and deviation of each ranking from the ideal scenario. The user then reviews the customized ranking and determines a target vulnerability that poses a greatest risk to the distributed system being protected based on priorities and resources of the distributed system. The user then provides a user command to the cyber security system to perform remediation of the target vulnerability.

At step 670, the custom ranking device receives a user command to perform a prioritized remediation of a target vulnerability selected by the user from the one or more vulnerabilities based on the customized ranking and specific needs of the distributed system.

At step 680, the cyber security framework performs the prioritized remediation of the target vulnerability.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A method of performing prioritized remediation of security weaknesses in a distributed system, comprising:
obtaining cyber security data including at least vulnerability data and intrusion detection system (IDS) rules;
determining a standard security weakness ranking based on the cyber security data;
determining that one or more vulnerabilities exist in one or more system components of the distributed system based on the standard security weakness ranking;
customizing metrics for calculating a likelihood of exploitation of each vulnerability and an exposure factor associated with exploitation of each vulnerability based on a user input including at least one variable for use in the calculation, the at least one variable influencing the likelihood of exploitation or the exposure factor and capturing a specific applicative domain of each vulnerability, priorities of the distributed system, and/or types of potential attackers;
calculating the customized metrics;
outputting a customized ranking of the one or more vulnerabilities based on the calculated customized metrics; and
performing a prioritized remediation of a target vulnerability selected by the user from the one or more vulnerabilities based on the customized ranking and specific needs and resources of the distributed system.

2. The method of claim 1, wherein the at least one variable belongs to a first set Xₗ^{↑} of variables that contribute to increasing the likelihood of exploitation as the value of the first set increases, a second set Xₗ^{↓} that contribute to decreasing the likelihood of exploitation as the value of the second set increases, a third set Xₑ^{↑} that contribute to increasing the exposure factor as the value of the third set increases, and a fourth set Xₑ^{↓} that contribute to decreasing the exposure factor as the value of the fourth set increases.

3. The method of claim 2, wherein the first set, the second set, the third set and the fourth set of variables are defined, respectively, as follows:
$${X}_{l}^{↑} = \{ X ∈ {X}_{l} \vert ( {∀}_{{v}_{1} {v}_{2}} ∈ V ) ( ( X ( {v}_{1} ) \leq X ( {v}_{2} ) Λ ( ( ∀ {X}^{′} ∈ χ ∖ \{ X \} ) ( X ( {v}_{1} ) = X ( {v}_{2} ) ) ) ) ⇒$$
$$ρ ( {v}_{1} ) \leq ρ ( {v}_{2} ) ) \} ;$$
$${X}_{l}^{↓} = \{ X ∈ {X}_{l} \vert ( {∀}_{{v}_{1} {v}_{2}} ∈ V ) ( ( X ( {v}_{1} ) \leq X ( {v}_{2} ) Λ ( ( ∀ {X}^{′} ∈ χ ∖ \{ X \} ) ( X ( {v}_{1} ) = X ( {v}_{2} ) ) ) ) ⇒$$
$$ρ ( {v}_{1} ) \geq ρ ( {v}_{2} ) ) \} ;$$
$${X}_{e}^{↑} = \{ X ∈ {X}_{e} \vert ( {∀}_{{v}_{1} {v}_{2}} ∈ V ) ( ( X ( {v}_{1} ) \leq X ( {v}_{2} ) Λ ( ( ∀ {X}^{′} ∈ χ ∖ \{ X \} ) ( X ( {v}_{1} ) = X ( {v}_{2} ) ) ) ) ⇒$$
$$ef ( {v}_{1} ) \leq e f ( {v}_{2} ) ) \} ; and$$
$${X}_{e}^{↓} = \{ X ∈ {X}_{e} \vert ( {∀}_{{v}_{1} {v}_{2}} ∈ V ) ( ( X ( {v}_{1} ) \leq X ( {v}_{2} ) Λ ( ( ∀ {X}^{′} ∈ χ ∖ \{ X \} ) ( X ( {v}_{1} ) = X ( {v}_{2} ) ) ) ) ⇒$$
$$ef ( {v}_{1} ) \geq e f ( {v}_{2} ) ) \} ;$$
where X is a variable, V is a set of all know vulnerabilities and v is a known vulnerability, ρ(v) is the likelihood of exploitation of the vulnerability v and ef(v) is the exposure factor of the vulnerability v.

4. The method of claim 3, wherein the likelihood ρ(v) of exploitation of each vulnerability is defined as a function ρ: V→[0,1] as follows:
$$ρ ( v ) = {Π}_{X ∈ {X}_{l}^{↑}} ( 1 - {e}^{- {α}_{x} \cdot {f}_{x} ( X ( v )} ) / {Π}_{X ∈ {X}_{1}^{↓}} {e}^{{β}_{x} \cdot {f}_{x} ( x ( v ) )}$$
and the exposure factor ef(v) associated with exploitation of each vulnerability is defined as a function ef: V→[0,1] as follows:
$$ef ( v ) = {Π}_{X ∈ {X}_{e}^{↑}} ( 1 - {e}^{- {a}_{x} \cdot {f}_{x} ( X ( v )} ) / {Π}_{X ∈ {X}_{e}^{↓}} {e}^{{β}_{x} \cdot {f}_{x} ( x ( v ) )}$$
where X is the variable, αₓ is atunable parameter, X(v) is the value of X for v, and ƒₓ is a monotonically increasing function used to convert values of X to scalar values, i.e., x1<x2⇒ƒₓ(x₁)≤ƒₓ(x₂).

5. The method of claim 3, wherein variables in the first set Xₗ^{↑} comprise at least an exploitability score of a vulnerability as captured by CVSS, time lapsed since publication of details about the vulnerability and a set of known vulnerability exploitations, wherein variables in the second set Xₗ^{↓} comprise at least a set of known IDS rules associated with a vulnerability and a set of vulnerability scanning plugins, wherein variables in the third set Xₑ^{↑} comprise at least an impact score of a vulnerability as captured by Common Vulnerability Scoring System (CVSS), and wherein variables in the fourth set Xₑ^{↓} comprise a set of deployed IDS rules associated with a vulnerability.

6. The method of claim 2, wherein the at least one variable comprises a plurality variables and each of the first set Xₗ^{↑}, the second set Xₑ^{↑}, the third set Xₑ^{↓}, or the fourth set Xₑ^{↓} includes at least one of the plurality of variables, and wherein the method further comprises:
providing a quality score of each customized rank; and
determining the target vulnerability based at least in part on the quality score.

7. The method of claim 6, wherein the quality score improves based on an increase in a number of the plurality of variables used in the calculation of the customized metrics.

8. The method of claim 2, further comprising:
adding one or more new variables to at least one of the first set Xₗ^{↑}, the second set Xₗ^{↓}, the third set Xₑ^{↑} or the fourth set Xₑ^{↓} based on a user selection in accordance with the priorities of the distributed system.

9. The method of claim 1, further comprising:
calculating severity scores for the one or more vulnerabilities based on the customized metrics, quality scores of respective customized ranks, and deviations of each customized rank from an ideal scenario in which each vulnerability has a unique severity score; and
outputting the severity scores, the quality scores, the deviations and cumulative number of vulnerabilities in each rank on a graphical user interface.

10. The method of claim 9, wherein the likelihood of exploitation and the exposure factor are combined into a severity score that allows ranking of the one or more vulnerabilities, the severity score is defined as s(v)=ρ(v)·ef(v), the quality score is defined as Q(r)=e^{-γ·δ}(r), and the ideal scenario is defines as δ(r)={square root over (Σᵢ₌₁^{r}(|CVE(r)|−1)²/r)},
where v is a vulnerability, ρ(v) is a likelihood of exploitation of the vulnerability, and ef(v) is an exposure factor of the exploitation of the vulnerability, γ is a tunable parameter and r is a rank, CVE denotes Common Vulnerability Exposures.

11. The method of claim 1, wherein the performing a prioritized remediation of a target vulnerability comprises:
prioritizing remediation of the one or more vulnerabilities based on the resources available for remediation and current needs of the distributed system; and
determining the target vulnerability that poses a greatest risk to the distributed system.

12. The method of claim 1, wherein the types of potential attackers comprises attackers who are aware of only the CVSS scores, attackers who have access to a system component associated with the one or more vulnerabilities, and attackers who can perform reconnaissance on the distributed system and discover unpatched vulnerabilities.

13. A cyber security system for performing a prioritized remediation of a security weaknesses in a distributed system, comprising:
a customized security risk remediator including:
a data ingestion device communicatively coupled to information sources for obtaining security data from the information sources, the information sources including at least a vulnerability database, one or more Intrusion Detection System (IDS) rules repositories, and one or more vulnerability scanners;
a ranking device structured to receive the security data and structured to output security weakness rankings periodically or on demand;
a metrics calculator structured to calculate metrics including a likelihood of exploitation of each vulnerability and an exposure factor associated with exploitation of each vulnerability;
a metrics customizer structured to customize the metrics based on a user input including at least one variable for use in the calculation, the at least one variable influencing the likelihood of exploitation or the exposure factor and capturing a specific applicative domain of each vulnerability, priorities of the distributed system, and/or types of potential attackers;
a target security risk remediation device structured to perform a prioritized remediation of a target vulnerability selected by a user from the one or more vulnerabilities based on the customized ranking and specific needs and resources of the distributed system; and
a user interface coupled to the customized security risk remediator and structured to receive the user input and output security weakness rankings including the customized rankings periodically or on demand.

14. The system of claim 13, wherein the at least one variable belongs to a first set Xₗ^{↑} of variables that contribute to increasing the likelihood of exploitation as the value of the first set increases, a second set Xₗ^{↓} that contribute to decreasing the likelihood of exploitation as the value of the second set increases, a third set Xₑ^{↑} that contribute to increasing the exposure factor as the value of the third set increases, and a fourth set Xₑ^{↓} that contribute to decreasing the exposure factor as the value of the fourth set increases.

15. The system of claim 14, wherein the first set, the second set, the third set and the fourth set of variables are defined, respectively, as follows:
$${X}_{l}^{↑} = \{ X ∈ {X}_{l} \vert ( {∀}_{{v}_{1} {v}_{2}} ∈ V ) ( ( X ( {v}_{1} ) \leq X ( {v}_{2} ) Λ ( ( ∀ {X}^{′} ∈ χ ∖ \{ X \} ) ( X ( {v}_{1} ) = X ( {v}_{2} ) ) ) ) ⇒$$
$$ρ ( {v}_{1} ) \leq ρ ( {v}_{2} ) ) \} ;$$
$${X}_{l}^{↓} = \{ X ∈ {X}_{l} \vert ( {∀}_{{v}_{1} {v}_{2}} ∈ V ) ( ( X ( {v}_{1} ) \leq X ( {v}_{2} ) Λ ( ( ∀ {X}^{′} ∈ χ ∖ \{ X \} ) ( X ( {v}_{1} ) = X ( {v}_{2} ) ) ) ) ⇒$$
$$ρ ( {v}_{1} ) \geq ρ ( {v}_{2} ) ) \} ;$$
$${X}_{e}^{↑} = \{ X ∈ {X}_{e} \vert ( {∀}_{{v}_{1} {v}_{2}} ∈ V ) ( ( X ( {v}_{1} ) \leq X ( {v}_{2} ) Λ ( ( ∀ {X}^{′} ∈ χ ∖ \{ X \} ) ( X ( {v}_{1} ) = X ( {v}_{2} ) ) ) ) ⇒$$
$$ef ( {v}_{1} ) \leq e f ( {v}_{2} ) ) \} ; and$$
$${X}_{e}^{↓} = \{ X ∈ {X}_{e} \vert ( {∀}_{{v}_{1} {v}_{2}} ∈ V ) ( ( X ( {v}_{1} ) \leq X ( {v}_{2} ) Λ ( ( ∀ {X}^{′} ∈ χ ∖ \{ X \} ) ( X ( {v}_{1} ) = X ( {v}_{2} ) ) ) ) ⇒$$
$$ef ( {v}_{1} ) \geq e f ( {v}_{2} ) ) \} ;$$
where X is a variable, V is a set of all know vulnerabilities and v is a known vulnerability, ρ(v) is the likelihood of exploitation of the vulnerability v and ef(v) is the exposure factor of the vulnerability v.

16. The system of claim 14, wherein the likelihood ρ(v) of exploitation of each vulnerability is defined as a function ρ: V→[0,1] as follows:
$$ρ ( v ) = {Π}_{X ∈ {X}_{l}^{↑}} ( 1 - {e}^{- {α}_{x} \cdot {f}_{x} ( X ( v )} ) / {Π}_{X ∈ {X}_{1}^{↓}} {e}^{{β}_{x} \cdot {f}_{x} ( X ( v ) )}$$
and the exposure factor ef(v) associated with exploitation of each vulnerability is defined as a function ef: V→[0,1] as follows:
$$ef ( v ) = {Π}_{X ∈ {X}_{e}^{↑}} ( 1 - {e}^{- {a}_{x} \cdot {f}_{x} ( X ( v )} ) / {Π}_{X ∈ {X}_{e}^{↓}} {e}^{{β}_{x} \cdot {f}_{x} ( X ( v ) )}$$
where X is the variable, ax is atunable parameter, X(v) is the value of X for v, and ƒₓ is a monotonically increasing function used to convert values of X to scalar values, i.e., x1<x2=ƒₓ(x₁)≤ƒₓ(x₂).

17. The system of claim 14, wherein variables in the first set Xₗ^{↑} comprise at least an exploitability score of a vulnerability as captured by CVSS, time lapsed since publication of details about the vulnerability and a set of known vulnerability exploitations, wherein variables in the second set Xₗ^{↓} comprise at least a set of known IDS rules associated with a vulnerability and a set of vulnerability scanning plugins, wherein variables in the third set Xₑ^{↑} comprise at least an impact score of a vulnerability as captured by Common Vulnerability Scoring System (CVSS), and wherein variables in the fourth set Xₑ^{↓} comprise a set of deployed IDS rules associated with a vulnerability.

18. The system of claim 13, further comprising:
plugins structured to interface with an individual virtual scanner; and
Application Programming Interfaces structured to interface with third party applications.

19. The system of claim 13, wherein the data ingestion device is further structured to generate and/or ingest vulnerability scanning reports, and the metrics further comprises a common weaknesses score as defined as S(CWEᵢ)=Σ_{v∈C(CWE}_{ᵢ}₎|I(v)|·ρ(v)·ef(v), where v is a vulnerability, I(v) is a set of instances of the vulnerability v within the system, CWEᵢ is a Common Weakness Enumeration weakness, C(CWEᵢ) is a set of common vulnerabilities and explores (CVEs) mapped to CWEᵢ, ρ(v) is the likelihood of exploitation of the vulnerability v and ef(v) is the exposure factor of the vulnerability v.

20. The system of claim 13, wherein the prioritized remediation of a target vulnerability is based at least in part on a prioritization of remediations of the one or more vulnerabilities based on the resources available for remediation and current needs of the distributed system and a determination that the target vulnerability that poses a greatest risk to the distributed system.
